(19) United States
(12) Patent Application Publication
(10) Pub. No.: US 2026/0098810 A1
(43) Pub. Date: Apr. 9, 2026

(54) SIMULTANEOUS CONFOCAL AND NON-CONFOCAL RAMAN SPECTROSCOPY

(71) Applicant: Onto Innovation Inc., Wilmington, MA (US)

(72) Inventors: Lei Tao, Bend, OR (US); David Papp, Bend, OR (US); Matthew Sartin, Budd Lake, NJ (US); Michael Gilmore, Bend, OR (US)

(73) Assignee: Onto Innovation Inc., Wilmington, MA (US)

(21) Appl. No.: 18/907,077

(22) Filed: Oct. 4, 2024

(51) Int. Cl. G01N 21/65; G02B 6/036

(52) U.S. Cl. CPC G01N 21/65; G02B 6/03633; G01N 2201/0833

(57) ABSTRACT

An optical metrology device simultaneously performs confocal and non-confocal Raman spectroscopy. The optical metrology device includes a double-clad fiber with a core that acts as a confocal pinhole to receive the confocal signal from the Raman response while simultaneously receiving the non-confocal signal from the Raman response over the inner cladding and core of the double-clad fiber. A spectrometer receives the Raman response via the double-clad fiber to detect the confocal spectroscopic signal from the core and to detect the non-confocal spectroscopic signal from the inner cladding and the core.

### FIELD OF THE DISCLOSURE

The subject matter described herein are related generally to non-destructive measurement of a sample, and more particularly to characterization of a sample using optical metrology.

### BACKGROUND

Semiconductor and other similar industries often use optical metrology equipment to provide non-contact evaluation of substrates during processing. With optical metrology, a sample under test is illuminated with light. After interacting with the sample, the resulting light is detected and analyzed to determine a desired characteristic of the sample.

One type of optical metrology that may be used to characterize the composition and phase of a materials as well as the stress in semiconductor device structures is Raman spectroscopy. Raman instruments rely on the use of a light source, such a laser, that is focused onto a sample to generate a Raman scattering response. Raman spectroscopy involves the interaction of the excitation light with the vibrational states of bonds in matter to produce the Raman scattering response. The Raman scattering response is collected and in turn measured by means of a spectrometer. The resulting spectroscopic signal may be used to determine one or more characteristics of the sample.

### SUMMARY

An optical metrology device simultaneously performs confocal and non-confocal Raman spectroscopy. The optical metrology device includes a double-clad fiber with a core that acts as a confocal pinhole to receive the confocal signal from the Raman response while simultaneously receiving the non-confocal signal from the Raman response over the inner cladding and core of the double-clad fiber. A spectrometer receives the Raman response via the double-clad fiber to detect the confocal spectroscopic signal from the core and to detect the non-confocal spectroscopic signal from the inner cladding and the core.

In one implementation, an optical metrology device for Raman spectroscopy includes a light source that generates a light beam and an objective lens that is configured to focus the light beam on a sample and to receive a Raman response emitted from the sample in response to the light beam. A double-clad fiber receives the Raman response. The double-clad fiber is configured to simultaneously receive a confocal signal for the Raman response at a core and at least a portion of a non-confocal signal for the Raman response at an inner cladding. A spectrometer is configured to simultaneously detect the confocal signal for the Raman response from the core and the at least the portion of the non-confocal signal for the Raman response from the inner cladding.

In one implementation, a method for Raman spectroscopy includes generating a light beam, focusing the light beam on a sample and receiving a Raman response emitted from the sample in response to the light beam. The method further includes receiving the Raman response with a double-clad fiber as a confocal signal that is received at a core of the double-clad fiber simultaneously with at least a portion of a non-confocal signal for the Raman response that is received at an inner cladding of the double-clad fiber. The method additionally includes detecting with a spectrometer the confocal signal for the Raman response from the core simultaneously with the at least the portion of the non-confocal signal for the Raman response from the inner cladding.

In one implementation, an optical metrology device for Raman spectroscopy includes a light source that generates a light beam and an objective lens configured to focus the light beam on a sample and to receive a Raman response emitted from the sample in response to the light beam. The optical metrology device includes a confocal pinhole that is a core of a double-clad fiber configured to receive a confocal signal from the Raman response. A non-confocal signal from the Raman response is received simultaneously with the confocal signal over the core and an inner cladding of the double-clad fiber. A spectrometer simultaneously detects a first spectrum from the core and a second spectrum from the inner cladding, and at least one processor that is coupled to the spectrometer receives a confocal spectroscopic signal as the first spectrum simultaneously with a non-confocal spectroscopic signal as the second spectrum combined with the first spectrum.

### BRIEF DESCRIPTION OF THE DRAWINGS

FIG. 1 illustrates a schematic representation of an optical metrology device employing Raman spectroscopy using a double-clad fiber configured to simultaneously receive a confocal Raman signal and a non-confocal Raman signal.

FIG. 2 illustrates a cross sectional view of a double-clad fiber and a graph of the corresponding refractive index profile of the double-clad fiber.

FIG. 3 illustrates a portion of a detector arm of the optical metrology device including a double-clad fiber coupled to a spectrometer.

FIG. 4 illustrates an example of the resulting spectral signals produced by the spectrometer in response to the confocal and non-confocal signals.

FIG. 5 illustrates a flow chart for a method of operation of an optical metrology device to perform Raman spectroscopy with simultaneously reception of a confocal Raman signal and a non-confocal Raman signal.

### DETAILED DESCRIPTION

During fabrication of semiconductor and similar devices it is sometimes necessary to monitor the fabrication process by non-destructively measuring the devices. Optical metrology is sometimes employed for non-contact evaluation of samples during processing.

One type of optical metrology that may be used to characterize the composition and phase of a materials as well as the stress in semiconductor device structures is Raman spectroscopy. Raman spectroscopy involves the interaction of light with the vibrational states of bonds in a sample. A Raman response is a nonlinear process that results of the scattering of light by the vibrating bonds where a particular bond is active if there is a change in polarizability (Raman active). The nonlinearity in Raman implies that a focused light beam will have the strongest Raman signal near the focal point which allows the analysis of a highly localized volume of a sample.

The incident light, however, does not only interact with the sample at the focal point, but will additionally interact within the sample at depths beyond the focal point. The use of a confocal optical geometry is useful in this respect as it allows further specificity of the measurement volume. A confocal optical geometry typically uses focused illumination and a pinhole, which is in an optically conjugate plane, before the detector to eliminate the out-of-focus signal. The “confocal” pinhole permits only light produced by fluorescence that is close to the focal plane to be detected. With a confocal optical geometry, the resulting optical resolution, particularly in the sample depth direction, is much better than that of non-confocal optical geometry, in which a confocal pinhole is not used, and an out-of-focus signal is detected. With a confocal optical geometry, however, a significant amount of the light produced from sample fluorescence is blocked at the confocal pinhole. Accordingly, while a confocal optical geometry provides increased resolution, this is at the cost of decreased signal intensity, which may increase sampling time and decrease the signal-to-noise ratio (SNR).

Confocal and non-confocal Raman spectroscopy both have their advantages and disadvantages for use in metrology, such as semiconductor metrology. In a Raman system, it may be desirable to use a confocal optical configuration in some situations, while a non-confocal optical configuration may be desirable in other situations. Thus, it may be desirable for a Raman spectroscopic device to switch between a confocal and non-confocal optical configuration depending on the requirements of measurements such as sample resolution, sampling time, SNR, etc. Switching between confocal and non-confocal optical configurations in a conventional Raman spectroscopic device, however, requires moving a confocal pinhole into and out of the optical path, which requires time, produces vibrations, and may result in errors caused by loss of calibration.

As discussed herein, a Raman spectroscopic device is capable of simultaneous detection of both confocal and non-confocal Raman signals without requiring movement of optical components such as confocal pinholes or other elements. The Raman spectroscopic device includes a double-clad fiber that is used to collect the Raman response light from the sample. The double-clad fiber includes a core, which collects the confocal Raman signal. The diameter of the core, thus, acts as the confocal pinhole. Simultaneously, the inner cladding collects the out-of-focus portion of the Raman response light. The full non-confocal Raman signal includes both the out-of-focus portion and the focused portion of the Raman response light and is, thus, collected over both the core and the inner cladding. Both the core and the inner cladding of the double-clad fiber feed into a spectrometer, which includes a two-dimensional detector array such as a CCD sensor. Spectra from the focused portion of the Raman response light, i.e., the confocal Raman signal, provided by the core is detected over a portion of the detector array, while simultaneously the spectra from the out-of-focus portion of the Raman response light provided by the inner cladding is detected over a different portion of the detector array. The full non-confocal Raman signal may be determined as the sum of the spectra produced based on light from both the core and the inner cladding. Accordingly, both the confocal and non-confocal Raman signal may be independently detected at the same time without physical alternation of the optical configuration of the Raman spectroscopic device.

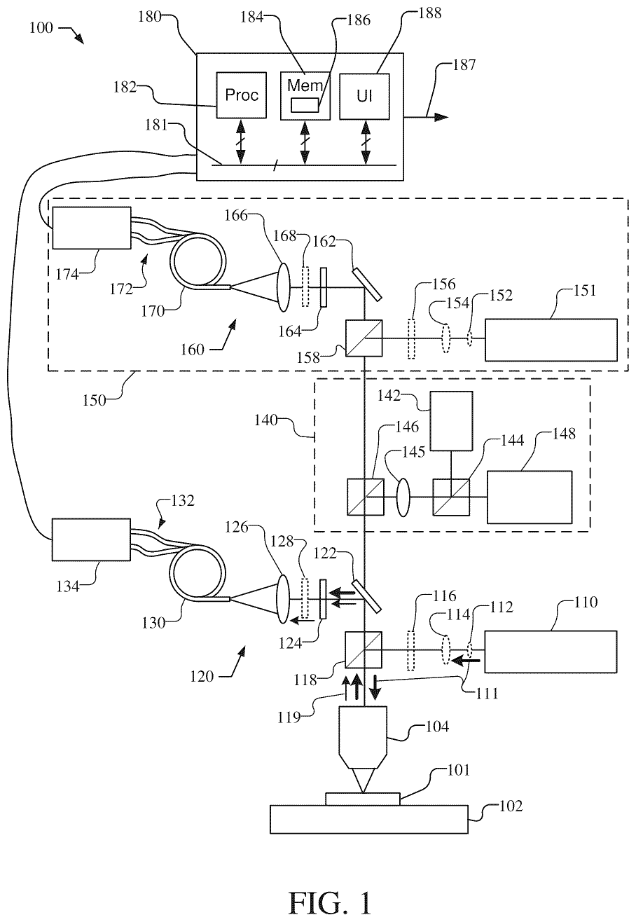

FIG. 1 illustrates a schematic representation of an optical metrology device 100 employing a Raman spectroscopic system using a double-clad fiber 130 that is configured to simultaneously receive the Raman response as a confocal signal and as a non-confocal signal.

Optical metrology device 100 includes a light source 110, such as a laser or other narrow band light source, that produces a light beam 111 with narrow band excitation frequencies, illustrated with thick arrows, that produce a Raman response by the sample 101 under test. The light beam 111 may be expanded and collimated respectively by a beam expander, such as lenses 112 and 114, and may be polarized with polarizer 116 and received by a beam splitter 118. The beam splitter 118 directs the light towards an objective lens 104, which focuses the light onto a sample 101 held on a stage 102.

The stage 102 (or a chuck coupled to the stage) holds the sample 101 and may be configured to move the sample 101 to desired measurement positions (and focal positions). For example, the stage 102 may include actuators that are controlled by a computing system 180 to move the sample 101 based on controls signals to position the sample 101 at desired measurement positions. The stage 102, for example, may be capable of horizontal motion in either Cartesian (i.e., X and Y) coordinates, or Polar (i.e., R and θ) coordinates or some combination of the two. The stage 102 may also be capable of vertical motion along the Z coordinate. In some implementations, one or more components of the optical system may move with respect to the stage 102 and sample 101 to position the optical system with respect to the sample 101 at desired measurement positions.

The light incident on the sample 101 is reflected and backscattered by the sample 101 as a response beam 119 that is received by the objective lens 104 and beam splitter 118. The interaction of the excitation frequencies in the incident light beam 111 with the vibrational states of bonds in the sample 101 produces the Raman scattering response, to produce the backscattered light. The backscattered light in response beam 119 has different frequencies than the excitation frequencies, which are illustrated as relatively thin arrows. The beam splitter 118 directs the response beam 119, including the reflected and backscattered light to a detector arm 120 including a double-clad fiber 130 that is configured to receive the response beam 119 as a confocal signal and as a non-confocal signal and provide both signals simultaneously to a spectrometer 134.

The detector arm 120 is illustrated as including an optional beam splitter 122 (or folding mirror) that directs the response beam 119 towards a Rayleigh rejection filter 124. The excitation frequencies, for example, are often orders of magnitude greater than Raman scattering response. Accordingly, a Rayleigh rejection filter 124, which may be an edge pass (or notch) filter is used to receive the response beam 119 and remove the excitation frequencies, so that the response beam 119 directed to the spectrometer 134 includes only the backscattered light (shown with the relatively thin arrow) without the excitation frequencies of the reflected light. In some implementations, the beam splitter 122 may be a dichroic beam splitter that directs the response beam 119 towards the spectrometer 134 and prevents other light, e.g., the excitation light from being directed towards the spectrometer 134. The use of the Rayleigh rejection filter 124 may still be desirable to prevent any undesired light from reaching the spectrometer 134.

Additionally, in some implementations, the detector arm 120 may include an analyzer 128, e.g., a linear polarizer, when the polarizer 116 is present. Thus, the excitation light and response light may be linearly polarized with known orientations. If desired, additional optical components may be included to rotate the polarization orientation, such as a rotating half-wave plate.

A lens 126 or lens system receives the backscattered light in the response beam 119 and focuses the light on the input of the double-clad fiber 130. The lens 126 provides a confocal signal to the core of the double-clad fiber 130. The diameter of the core of the double-clad fiber 130 serves as the confocal pinhole. The lens 126 simultaneously provides a non-confocal signal to the double-clad fiber 130, e.g., over the core and the inner cladding of the double-clad fiber 130. A Y-bundle 132 separates the core and the inner cladding, which feed into the spectrometer 134 to provide the confocal signal and the non-confocal signal simultaneously to the spectrometer 134.

In some implementations, the optical metrology device 100 may include additional components, such as imaging components or additional Raman spectroscopic systems.

For example, an imaging system 140 may include a light source 142, such as a light emitting diode (LED) or polychromatic lamp may produce light that is directed to the objective lens 104 via a first beam splitter 144 and a second beam splitter 146 (or mirror), and conditioning lens 145. The light is received by the objective lens 104 via the beam splitter 122 and beam splitter 118, and focused on the sample 101. The light reflected from the sample 101 is returned to the second beam splitter 146 (or mirror), via the objective lens 104, beams splitter 118, and beam splitter 122, and is directed to a camera 148 via the lens 145 and the first beam splitter 144.

In some implementations, the optical metrology device 100 may employ multi wavelength polarized confocal and non-confocal Raman spectroscopy, e.g., using a multiple light sources with different excitation wavelengths that produce a Raman response from the sample having different (non-overlapping) ranges of wavelengths. As illustrated, the optical metrology device 100 may include a second Raman spectroscopic device 150, which may use a double-clad fiber 170 that is configured to receive a confocal signal and a non-confocal signal simultaneously. The second Raman spectroscopic device 150 may be similar to the previously described Raman spectroscopic system including a light source 151 that produces light with narrow band excitation frequencies, which differ from that produced by light source 110.

By way of example, the light sources 110 and 151 may provide excitation light with different wavelengths, such as different bands within the visible wavelengths, ultraviolet (UV) wavelengths, or infrared (IR) or near IR wavelengths. For example, light source 110 may produce light with a wavelength of 325 nm and light source 151 may produce light with a wavelength of 785 nm, but other wavelengths may be used if desired.

The light from light source 151 may be expanded and collimated respectively by lenses 152 and 154, and may be polarized with polarizer 156 and received by a beam splitter 158. The beam splitter 158 directs the excitation light from the light source 151 towards the objective lens 104, via beam splitter 146 (if present), and beam splitters 122 and 118. The response light from the sample 101, which includes reflected excitation light and light that is backscattered in response to the excitation frequencies, is received by beam splitter 158, via objective lens 104, beam splitters 118 and 122, and beam splitter 146 (if present), and is directed to the detector arm 160. The beam splitters 118, 122, 146, and 158, for example, may be dichroic beam splitters, which are used to combine the excitation light (and imaging light from imaging system 140) and to filter the excitation light from the Raman responses and to separate the Raman responses. For example, beam splitters 122 and 118 may be dichroic beam splitters that pass the excitation light and the response light from and to the second Raman spectroscopic device 150, as well as the light from imaging system 140. The beam splitter 146 may also be a dichroic beam splitter that passes the excitation light and the response light from and to the second Raman spectroscopic device 150. The beam splitter 158 may be a dichroic beam splitter that directs the excitation light towards the objective lens 104 and directs the response beam towards the spectrometer 174, while preventing other light, e.g., the excitation light from light source 151, the imaging light from imaging system 140, or any stray excitation light or response light from light source 110, from being directed towards the spectrometer 174.

The detector arm 160 in the second Raman spectroscopic device 150 is illustrated as including an optional folding mirror 162 that directs the response beam towards a Rayleigh rejection filter 164 that is configured to remove the excitation frequencies produced by light source 151, e.g., which may be reflected by the sample 101 or any intervening optical components. The response beam, which includes only the backscattered light, may pass through an optional analyzer 168 (e.g., used if polarizer 156 is present), and is focused by lens 166 or lens system on the input of the double-clad fiber 170. The lens 166 provides a confocal signal to the core of the double-clad fiber 170. The diameter of the core serves as the confocal pinhole. The lens 166 simultaneously provides a non-confocal signal to the double-clad fiber 170, e.g., over the core and the inner cladding. A Y-bundle 172 separates the core and the inner cladding, which feed into the spectrometer 174 to provide the confocal signal and the non-confocal signal simultaneously. In some implementations, the Y-bundle 172 may feed into the spectrometer 134 to provide the confocal signal and the non-confocal signal simultaneously to the spectrometer 134, thereby obviating the use of a second spectrometer 174.

The spectrometer 134 and spectrometer 174 (if used), as well as other components of the optical metrology device 100, such as the light source and light sources 142 and 151 (if used), polarizers 116 and 156 (if used), analyzers 128 and 168 (if used), and the stage 102, may be coupled to at least one computing system 180, such as a workstation, a personal computer, central processing unit or other adequate computer system, or multiple systems. It should be understood that the computing system 180 includes one or more processing units 182 that may be separate or linked processors, and computing system 180 may be referred to herein sometimes as a processor 180, at least one processor 180, one or more processors 180, etc. The computing system 180 is preferably included in, or is connected to, or otherwise associated with optical metrology device 100. The computing system 180, for example, may control the positioning of the sample 101, e.g., by controlling movement of the stage 102 on which the sample 101 is held. The computing system 180 may further control the operation of a chuck on the stage 102 used to hold or release the sample 101. The computing system 180 may also collect and analyze the data obtained from the spectrometers 134 and 174 (if used). The computing system 180 may analyze the data to determine one or more physical characteristics of the sample, e.g., based on Raman scattering as discussed above, for the multiple excitation wavelengths employed. In some implementations, the measured data may be obtained and compared to a modeled data, which may be stored in a library or obtained in real time. Parameters of the model may be varied, and modeled data compared to the measured data, e.g., in a linear regression process, until a good fit is achieved between the modeled data and the measured data, at which time the modeled parameters are determined to be the characteristics of the sample 101.

The computing system 180 includes at least one processing unit 182 and non-transitory computer-usable storage medium 184 such as memory, as well as a user interface 188 including, e.g., a display and input devices, which may be coupled via a bus 181. A non-transitory computer-usable storage medium 184 having computer-readable program code 186 embodied may be used by the at least one processor 182 for causing the at least one processor 182 to control the optical metrology device 100 and to perform the measurement functions and analysis described herein. The data structures and software code for automatically implementing one or more acts described in this detailed description can be implemented by one of ordinary skill in the art in light of the present disclosure and stored, e.g., on a computer-usable storage medium 184, which may be any device or medium that can store code and/or data for use by a computer system such as processing unit 182. The computer-usable storage medium 184 may be, but is not limited to, flash drive, magnetic and optical storage devices such as disk drives, magnetic tape, compact discs, and DVDs (digital versatile discs or digital video discs). A communication port 187 may also be used to receive instructions that may be stored on memory and used to program the processor 182 to perform any one or more of the functions described herein and may represent any type of communication connection, such as to the internet or any other computer network. The communication port 187 may further export signals, e.g., with measurement results and/or instructions, to another system, such as external process tools, in a feed forward or feedback process in order to adjust a process parameter associated with a fabrication process step of the samples based on the measurement results. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory, associated with the sample and/or provided to a user, e.g., via UI 188, using a display, an alarm, data set, or other output device. Moreover, the results from the analysis may be fed back to the process equipment to adjust the appropriate patterning step to compensate for any detected variances in the processing.

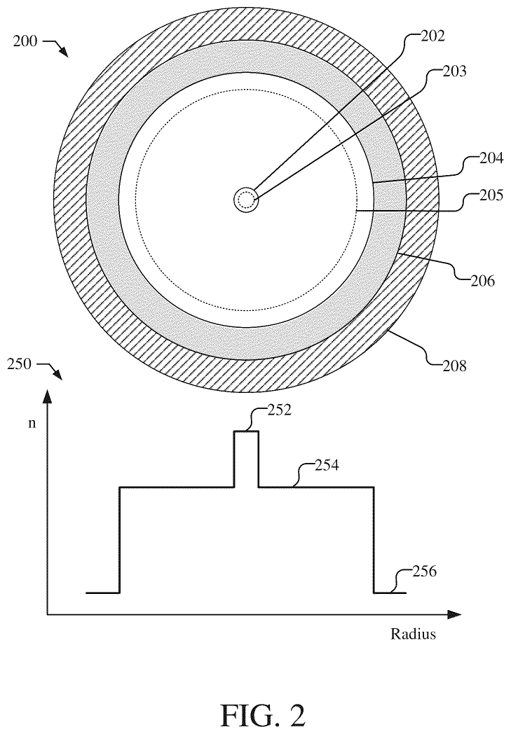

FIG. 2 illustrates a cross sectional view of a double-clad fiber 200, which may be used as double-clad fibers 130 and 170 shown in FIG. 1, and a graph 250 of the corresponding refractive index n profile of the double-clad fiber 200.

The double-clad fiber 200 is an optical fiber that includes three layers of optical material, including the core 202 surrounded by an inner cladding 204, which is surrounded by an outer cladding 206, and all of which is surrounded by a jacket 208. The core 202, inner cladding 204, and outer cladding 206 are optical materials with different refractive indices. As illustrated by graph 250, the core 202 has the highest refractive index indicated by area 252, followed by the inner cladding 204 as indicated by area 254, and the outer cladding 206 as indicated by area 256. The interface between the core 202 and the inner cladding 204 act as a waveguide for light that is incident on the core 202, as illustrated by dotted lines 203. Similarly, the interface between the inner cladding 204 and outer cladding 206 act as a waveguide for light that is incident on the inner cladding 204.

Accordingly, in operation, the confocal light from the Raman spectroscopic device, such as illustrated in FIG. 1, may be incident on the core 202 as illustrated by dotted lines 203 and the core 202 and inner cladding 204 serve as a waveguide to direct the confocal light to the spectrometer 134 via the Y-bundle 132. The diameter of the core 202, thus, may serve as the confocal pinhole. The non-confocal light from the Raman spectroscopic device may be incident over the inner cladding 204 and the core 202, as illustrated by dotted lines 205, and the waveguide produced by the outer cladding 206 and inner cladding 204, as well as the waveguide produced by the core 202 and inner cladding 204, direct the non-confocal light to the spectrometer 134 via the Y-bundle 132.

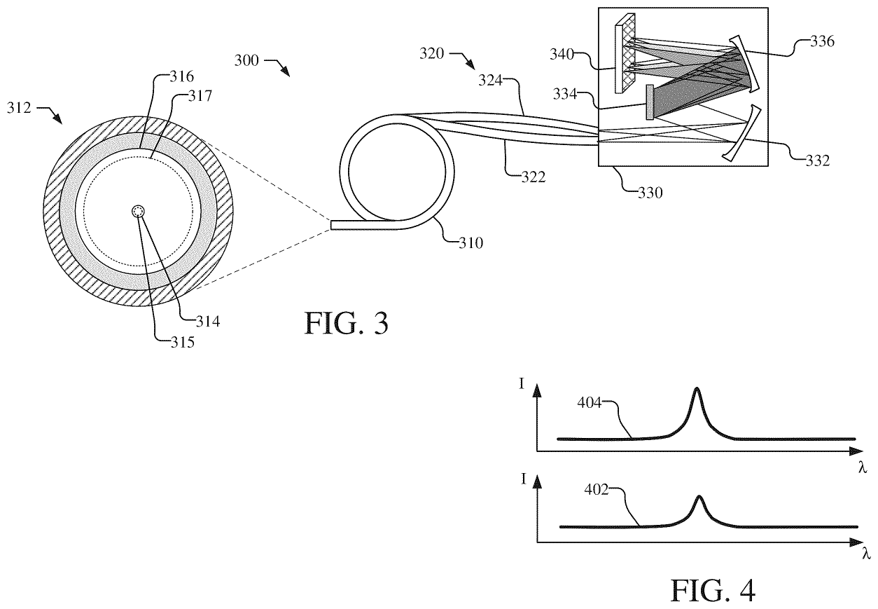

FIG. 3 illustrates a portion of a detector arm 300 including a double-clad fiber 310 coupled to a spectrometer 330 via a Y-bundle 320. The detector arm 300, for example, may be used as the detector arms 120 and 160 shown in FIG. 1. FIG. 3 illustrates the cross-sectional view 312 of the double-clad fiber 310, as illustrated in FIG. 2, including the confocal light 315 focused on the core 314 and the non-confocal light 317 focused over the inner cladding 316 and the core 314.

The Y-bundle 320 is coupled to the double-clad fiber 310 and includes a fiber 322 that is coupled to the core 314 and provides the confocal light 315 to the spectrometer 330. The Y-bundle 320 further includes a fiber 324 that is coupled to the inner cladding 316 and provides a portion of the non-confocal light 317 to the spectrometer 330, where the fiber 322 coupled to the core 314 brings the remaining portion of the non-confocal light 317 to the spectrometer 330.

The spectrometer 330 is coupled to receive the confocal light via fiber 322 and the non-confocal light via fiber 324 (and optionally from fiber 322). The spectrometer 330 includes mirrors 332 and 336 and a diffraction grating 334 that receive the confocal light from fiber 322 and the non-confocal light from fiber 324. A detector 340, such as a CCD camera including a two dimensional array of pixels, receives the resulting confocal spectral signal and the resulting non-confocal spectral signal from mirrors 332 and 336 and diffraction grating 334. The confocal spectral signal and the non-confocal spectral signal received by the detector 340 may have no overlap. In some implementations, a separate set of mirrors, a separate diffraction grating, a separate detectors, or any combination thereof, may be used to receive the non-confocal spectral signal separately from the confocal spectral signal. Additionally, in some implementations, such as where a second Raman spectroscopic device is used, the spectrometer 330 may additionally receive the confocal and non-confocal light for the second Raman spectroscopic device, using the same or different mirrors, diffraction grating and detector.

FIG. 4 illustrates an example of the resulting spectral signals 402 and 404 produced by the detector 340 shown in FIG. 3. The spectral signal 402, for example, is produced based on the light incident on the core 314 that is received from fiber 322, and corresponds to the confocal spectral signal. The spectral signal 404, on the other hand, is produced based on the light incident on the inner cladding 316 that is received from fiber 324. The non-confocal light, however, is incident over the inner cladding 316 as well as the core 314. Accordingly, the non-confocal spectral signal may be generated as the sum of the spectral signal 402 and spectral signal 404.

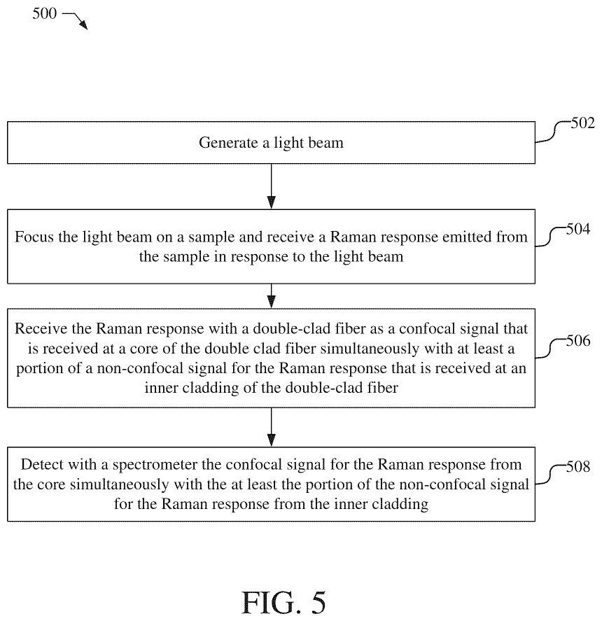

FIG. 5 is a flow chart 500 illustrating a method of operation of an optical metrology device, such as optical metrology device 100 to perform Raman spectroscopy, as discussed herein.

As illustrated by block 502, the optical metrology device generates a light beam. A means for generating the light beam may be a light source, such as a laser or other narrow band light source, configured to produce narrow band excitation frequencies to induce a Raman response in a sample under test, such as light source 110 discussed in reference to FIG. 1.

At block 504, the light beam is focused on the sample and a Raman response emitted from sample in response to the light beam is received. A means for focusing the light beam on the sample and receiving the emitted Raman response may be, e.g., one or more lenses, such as objective lens 104 discussed in reference to FIG. 1.

At block 506, the Raman response is received with a double-clad fiber as a confocal signal that is received at a core of the double-clad fiber simultaneously with at least a portion of a non-confocal signal for the Raman response that is received at an inner cladding of the double-clad fiber, e.g., as illustrated by double-clad fiber 130, 200, and 310 discussed in reference to FIGS. 1, 2, and 3, respectively.

At block 508, a spectrometer detects the confocal signal for the Raman response from the core simultaneously with the at least the portion of the non-confocal signal for the Raman response from the inner cladding, e.g., as illustrated by spectrometer 134 and 330 discussed in reference to FIGS. 1, 3, and 4.

The method may further include, in some implementations, receiving with at least one processor a confocal spectroscopic signal and a non-confocal spectroscopic signal from the spectrometer, and determining one or more characteristics of the sample based on the confocal spectroscopic signal and the non-confocal spectroscopic signal, e.g., as discussed in reference to computing system 180 with one or more processing units 182 shown in FIG. 1.

In some implementations, the spectrometer simultaneously detects a first spectrum from the core and a second spectrum from the inner cladding at separate detector pixels. By way of example, a detector, such as a CCD camera including a two dimensional array of pixels, is used to detect a spectral signals based on light received from the core and inner cladding, as discussed in reference to FIGS. 3 and 4. The non-confocal signal for the Raman response, for example, may be received at the inner cladding and the core, and the spectrometer may detect the non-confocal signal as a combination of the first spectrum and the second spectrum, e.g., as discussed in reference to FIGS. 3 and 4.

In some implementations, the core of the double-clad fiber is a confocal pinhole, which, e.g., receives the confocal signal and at least a portion of the non-confocal signal from the Raman response.

The method may further include, in some implementations, filtering the Raman response to remove the light beam before the Raman response is received by the double-clad fiber. A means for filtering the Raman response, for example, may be one or both of a filter, such as Rayleigh rejection filter 124, and a dichroic beam splitter 122, discussed in reference to FIG. 1. Additionally, the Raman response is focused on an end of the double-clad fiber centered on the core after filtering to remove the light beam. A means for focusing the Raman response on an end of the double-clad fiber may be one or more lenses, such as lens 126 discussed in reference to FIG. 1.

In some implementations, the method may further include generating a second light beam. A means for generating the second light beam, for example, may be a second light source that produces excitation frequencies to induce a Raman response and that differ from the excitation frequencies in the light beam, and may be, e.g., light source 151 in the second Raman spectroscopic device 150 discussed in reference to FIG. 1. The second light beam may be focused on the sample and a second Raman response emitted from the sample in response to the second light beam is received, e.g., by the objective lens 104. The second Raman response is received with a second double-clad fiber as a second confocal signal that is received at a second core of the second double-clad fiber simultaneously with at least a portion of a second non-confocal signal for the second Raman response that is received at a second inner cladding of the second double-clad fiber, e.g., as illustrated by the second double-clad fiber 170 in the second Raman spectroscopic device 150 discussed in reference to FIG. 1. The second confocal signal for the second Raman response from the second core is detected simultaneously with the at least the portion of the second non-confocal signal for the second Raman response from the second inner cladding. A means for detecting simultaneously the second confocal signal and the at least the portion of the second non-confocal signal may be a second spectrometer 174 in the second Raman spectroscopic device 150 or the spectrometer 134 discussed in reference to FIG. 1.

In some implementations, the method may further include polarizing the light beam before the light beam is incident on the sample, e.g., with a means such as polarizer 116 discussed in reference to FIG. 1. The Raman response may be analyzed with a polarizer before receiving the Raman response with the double-clad fiber, e.g., with a means such as analyzer 128 discussed in reference to FIG. 1.

In some implementations, the method may further include expanding and collimating the light beam before focusing the light beam on the sample, e.g., with a means such as lenses 112 and 114 shown in FIG. 1.

Although the present disclosure is illustrated in connection with specific implementations for instructional purposes, the scope of the technology is not limited thereto. Moreover, while different examples and implementations may be described separately, such examples and implementations may be combined with one another in implementing the technology described herein. One skilled in the art will recognize other implementations and improvements that are within the scope and spirit of the present technology. Therefore, the specific structure, acts, or media are disclosed only as illustrative examples. The scope of the technology should not be limited to the foregoing description.

What is claimed is:

1. An optical metrology device for Raman spectroscopy, comprising:
a light source that generates a light beam;
an objective lens configured to focus the light beam on a sample and to receive a Raman response emitted from the sample in response to the light beam;
a double-clad fiber that receives the Raman response, the double-clad fiber configured to simultaneously receive a confocal signal for the Raman response at a core and at least a portion of a non-confocal signal for the Raman response at an inner cladding; and
a spectrometer configured to simultaneously detect the confocal signal for the Raman response from the core and the at least the portion of the non-confocal signal for the Raman response from the inner cladding.

2. The optical metrology device of claim 1, at least one processor coupled to receive a confocal spectroscopic signal and a non-confocal spectroscopic signal from the spectrometer and to determine one or more characteristics of the sample based on the confocal spectroscopic signal and the non-confocal spectroscopic signal.

3. The optical metrology device of claim 1, wherein the spectrometer simultaneously collects a first spectrum from the core and a second spectrum from the inner cladding at separate detector pixels.

4. The optical metrology device of claim 3, wherein the non-confocal signal for the Raman response is received at the inner cladding and the core, and the spectrometer detects the non-confocal signal as a combination of the first spectrum and the second spectrum.

5. The optical metrology device of claim 1, wherein the core is a confocal pinhole.

6. The optical metrology device of claim 1, further comprising:
a filter that removes the light beam from the Raman response before the Raman response is received with double-clad fiber; and
a lens that receives the Raman response from the filter and focuses the Raman response on an end of the double-clad fiber centered on the core.

7. The optical metrology device of claim 1, further comprising:
a second light source that generates a second light beam;
wherein the objective lens is further configured to focus the second light beam on the sample and to receive a second Raman response emitted from the sample in response to the second light beam;
a second double-clad fiber that receives the second Raman response, the second double-clad fiber configured to simultaneously receive a second confocal signal for the second Raman response at a second core of the second double-clad fiber and at least a portion of a second non-confocal signal for the second Raman response at a second inner cladding of the second double-clad fiber; and
a second spectrometer configured to simultaneously receive the second confocal signal for the second Raman response from the second core and the at least the portion of the second non-confocal signal for the second Raman response from the second inner cladding.

8. The optical metrology device of claim 1, further comprising:
a polarizer disposed between the light source and the objective lens; and
an analyzer disposed between the objective lens and the double-clad fiber.

9. The optical metrology device of claim 1, further comprising a beam expander disposed between the light source and the objective lens.

10. A method for Raman spectroscopy, comprising:
generating a light beam;
focusing the light beam on a sample and receiving a Raman response emitted from the sample in response to the light beam;
receiving the Raman response with a double-clad fiber as a confocal signal that is received at a core of the double-clad fiber simultaneously with at least a portion of a non-confocal signal for the Raman response that is received at an inner cladding of the double-clad fiber; and
detecting with a spectrometer the confocal signal for the Raman response from the core simultaneously with the at least the portion of the non-confocal signal for the Raman response from the inner cladding.

11. The method of claim 10, further comprising:
receiving with at least one processor a confocal spectroscopic signal and a non-confocal spectroscopic signal from the spectrometer; and
determining one or more characteristics of the sample based on the confocal spectroscopic signal and the non-confocal spectroscopic signal.

12. The method of claim 10, wherein the spectrometer simultaneously detects a first spectrum from the core and a second spectrum from the inner cladding at separate detector pixels.

13. The method of claim 12, wherein the non-confocal signal for the Raman response is received at the inner cladding and the core, and the spectrometer detects the non-confocal signal as a combination of the first spectrum and the second spectrum.

14. The method of claim 10, wherein the core is a confocal pinhole.

15. The method of claim 10, further comprising:
filtering the Raman response to remove the light beam before the Raman response is received by the double-clad fiber; and
focusing the Raman response on an end of the double-clad fiber centered on the core after filtering to remove the light beam.

16. The method of claim 10, further comprising:
generating a second light beam;
focusing the second light beam on the sample and receiving a second Raman response emitted from the sample in response to the second light beam;
receiving the second Raman response with a second double-clad fiber as a second confocal signal that is received at a second core of the second double-clad fiber simultaneously with at least a portion of a second non-confocal signal for the second Raman response that is received at a second inner cladding of the second double-clad fiber; and
detecting the second confocal signal for the second Raman response from the second core simultaneously with the at least the portion of the second non-confocal signal for the second Raman response from the second inner cladding.

17. The method of claim 10, further comprising:
polarizing the light beam before the light beam is incident on the sample; and
analyzing the Raman response with a polarizer before receiving the Raman response with the double-clad fiber.

18. The method of claim 10, further comprising expanding and collimating the light beam before focusing the light beam on the sample.

19. An optical metrology device for Raman spectroscopy, comprising:
a light source that generates a light beam;
an objective lens configured to focus the light beam on a sample and to receive a Raman response emitted from the sample in response to the light beam;
a confocal pinhole comprising a core of a double-clad fiber to receive a confocal signal from the Raman response, wherein a non-confocal signal from the Raman response is received simultaneously with the confocal signal over the core and an inner cladding of the double-clad fiber;
a spectrometer that simultaneously detects a first spectrum from the core and a second spectrum from the inner cladding; and
at least one processor coupled to the spectrometer to receive a confocal spectroscopic signal as the first spectrum simultaneously with a non-confocal spectroscopic signal as the second spectrum combined with the first spectrum.

20. The optical metrology device of claim 19, wherein the at least one processor is configured to one or more characteristics of the sample based on the confocal spectroscopic signal and the non-confocal spectroscopic signal.
